(19) United States
(12) Patent Application Publication
(10) Pub. No.: US 2025/0209563 A1
(43) Pub. Date: Jun. 26, 2025

(54) IN-LINE ERROR CORRECTION FOR MOTION ESTIMATION AND DEPTH FROM STEREO

(71) Applicant: QUALCOMM Incorporated, San Diego, CA (US)

(72) Inventors: Samuel Benjamin HOLMES, Sterling, MA (US); Jonathan WICKS, Lafayette, CO (US)

(21) Appl. No.: 18/393,527

(22) Filed: Dec. 21, 2023

(51) Int. Cl. G06T 1/20; G06T 7/00; G06T 7/207

(52) U.S. Cl. CPC G06T 1/20; G06T 7/0002; G06T 7/207

(57) ABSTRACT

This disclosure provides systems, devices, apparatus, and methods, including computer programs encoded on storage media, for in-line error correction for ME and DFS. A processor identifies, in-line, a set of error regions associated with a first frame. The processor performs, in-line and based on the identified set of error regions and partial ME results of a first ME pass and/or partial DFS results of a first DFS pass, a set of iterative downscale passes on the partial ME results and/or the partial DFS results. The processor generates, in-line, a global motion buffer based on the performed set of iterative downscale passes. The processor performs, based on the global motion buffer and/or the identified set of error regions, a second ME pass and/or a second DFS pass.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for hierarchical motion estimation (ME) and hierarchical depth from stereo (DFS) may not address errors introduced early in the hierarchical ME process or the hierarchical DFS process. There is a need for improved techniques for hierarchical ME and/or hierarchical DFS.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing are provided. The apparatus includes a memory; and a processor coupled to the memory and, based on information stored in the memory, the processor is configured to: identify, in-line, a set of error regions associated with a first frame; perform, in-line and based on the identified set of error regions and at least one of partial motion estimation (ME) results of a first ME pass or partial depth from stereo (DFS) results of a first DFS pass, a set of iterative downscale passes on at least one of the partial ME results or the partial DFS results; generate, in-line, a global motion buffer based on the performed set of iterative downscale passes; and perform, based on at least one of the global motion buffer or the identified set of error regions, at least one of a second ME pass or a second DFS pass.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4 is a diagram illustrating example aspects of motion estimation (ME) in accordance with one or more techniques of this disclosure.

FIG. 5 is a diagram illustrating examples of an ME process and an enhanced ME process in accordance with one or more techniques of this disclosure.

FIG. 6 is a diagram illustrating example aspects pertaining to metrics used for identifying error regions in an ME process in accordance with one or more techniques of this disclosure.

FIG. 7 is a diagram illustrating further example aspects pertaining to metrics used for identifying error regions in an ME process in accordance with one or more techniques of this disclosure.

FIG. 8 is a diagram illustrating example aspects pertaining to flagging error regions in accordance with one or more techniques of this disclosure.

FIG. 9 is a diagram illustrating example aspects pertaining to downscale passes and a global motion buffer in accordance with one or more techniques of this disclosure.

FIG. 10 is a diagram illustrating example aspects pertaining to source selection for an ME process in accordance with one or more techniques of this disclosure.

FIG. 11 is a call flow diagram illustrating example communications between a first graphics processor component and a second graphics processor component in accordance with one or more techniques of this disclosure.

FIG. 12 is a flowchart of an example method of graphics processing in accordance with one or more techniques of this disclosure.

FIG. 13 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Motion Estimation (ME) and Depth from Stereo (DFS) may refer to two image-based techniques to produce motion vectors/disparity values, respectively, between a pair of images. A motion vector may refer to a two dimensional (2D) quantity that describes a transformation from a location in a first 2D image to a second location in a 2D image (e.g., the amount of X and Y movement an object makes in adjacent video frames). A disparity value may refer to a one-dimensional (1D) quantity which describes a shift along a single axis from a first location in a 2D image and a second location in the 2D image (e.g., the amount an object moves in X between a left and right image in a stereo pair of images). ME may be used to interpolate motion between frames (i.e., estimate motion between a first frame and a second frame based on a first position associated with the first frame and a second position associated with the second frame) or to extrapolate positions for future frames. DFS may be used to determine depths of content in a pair of images. ME or DFS may be performed in a hierarchical ME process or a hierarchical DFS process. A hierarchical ME/DFS process may include multiple passes, where each pass may refine an output of the previous pass, and where a final pass may produce a final motion vector or a final disparity value. Compared to other types of ME/DFS processes (e.g., full search, heuristic based approaches), hierarchical ME/DFS processes may offer low computational complexity, high efficiency, and/or flexibility.

An image pair may include characteristics which may introduce errors into motion vectors/disparity values generated by an ME process or a DFS process, respectively. For instance, the characteristics may include featureless regions in the image pair, aperture issues, and/or repeated patterns in the image pair. When the errors are introduced in an early level of a hierarchical ME process or a hierarchical DFS process, the errors may be propagated to later levels of the hierarchical ME process or the hierarchical DFS process, which may impact a quality of a final motion vector or a final disparity value of the hierarchical ME process or the hierarchical DFS process.

Various technologies pertaining to in-line error correction for ME and DFS are described herein. In an example, an apparatus (e.g., a graphics processor) identifies, in-line, a set of error regions associated with a first frame. As used herein, the term error region may refer to a region of at least one image associated with misidentified motion. The apparatus performs, in-line and based on the identified set of error regions and at least one of partial motion estimation (ME) results of a first ME pass or partial depth from stereo (DFS) results of a first DFS pass, a set of iterative downscale passes on at least one of the partial ME results or the partial DFS results. The apparatus generates, in-line, a global motion buffer based on the performed set of iterative downscale passes. The apparatus performs, based on at least one of the global motion buffer or the identified set of error regions, at least one of a second ME pass or a second DFS pass. Vis-à-vis identifying the set of error regions, performing the set of iterative downscale passes, and generating the global motion buffer in-line, the apparatus may remove errors early in a hierarchical ME process and/or a hierarchical DFS process, which may facilitate high quality final outputs for the hierarchical ME process and/or the hierarchical DFS process. For example, the high quality final outputs may accurately describe motion between successive video frames or the high quality final outputs may accurate describe depths of content in a left image and a right image. In one aspect, the apparatus may identify the set of error regions based on at least one of a variance of a set of block matches of at least one of the first ME pass or the first DFS pass, a symmetry metric associated with the set of block matches, or a comparison of a set of positions of the set of block matches, which may further facilitate removing errors early in a hierarchical ME process and/or a hierarchical DFS process.

When performing motion estimation (ME) and/or depth from stereo (DFS) operations, there may be patterns in input content which introduce errors into resulting vectors for the ME and/or DFS operations, which may lead to poor quality results. There may be several classes of input content which may cause errors: 1) repeating patterns, 2) flat/featureless regions, and 3) aperture issues. In one aspect described herein, in-line processing may be added during a hierarchal ME search in order to correct these issues caused by the aforementioned classes of input content. In a first step, a device may identify error regions. With more particularity, three metrics may be used to first identify and flag error regions. These metrics may be used to flag problematic vectors in-line while performing an initial motion search. In a second step, once error regions are identified, a device may use this information in conjunction with partial motion estimation results to perform an iterative set of conditional downscale passes which utilize flag information to discard low quality vectors and utilize high quality vectors to create a lower resolution global motion buffer. In a third step, the device may combine the intermediate results from the initial motion search, the flagged vector information identified by the metrics, and the global motion buffer at a top of a following refinement motion estimation pass in order to remove error vectors in-line and early in the ME process. By doing so, refinement search passes may operate on clean data, eliminating the error values and producing a high quality final output for the ME/DFS operation.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

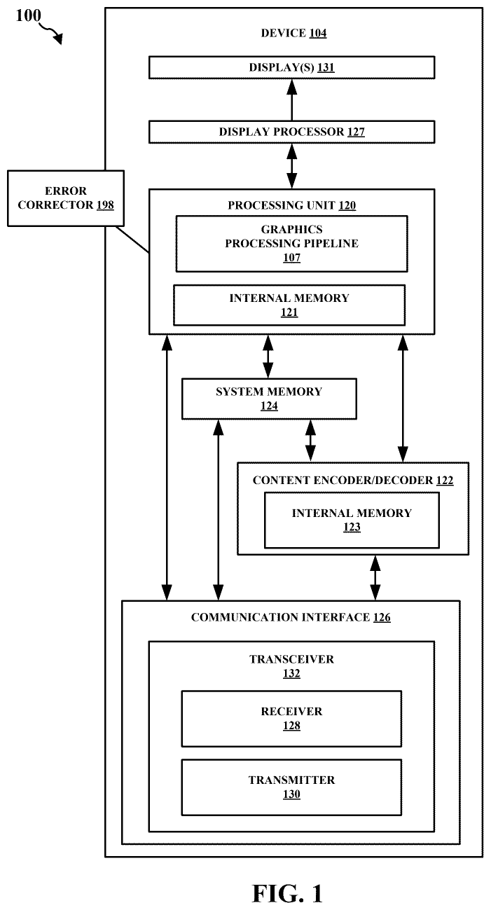

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an error corrector 198 configured to identify, in-line, a set of error regions associated with a first frame; perform, in-line and based on the identified set of error regions and at least one of partial motion estimation (ME) results of a first ME pass or partial depth from stereo (DFS) results of a first DFS pass, a set of iterative downscale passes on at least one of the partial ME results or the partial DFS results; generate, in-line, a global motion buffer based on the performed set of iterative downscale passes; and perform, based on at least one of the global motion buffer or the identified set of error regions, at least one of a second ME pass or a second DFS pass. Although the following description may be focused on graphics processing, the concepts described herein may be applicable to other similar processing techniques. Furthermore, although the concepts described herein may focus on motion estimation (ME), the concepts presented herein may also be applicable to depth from stereo (DFS).

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

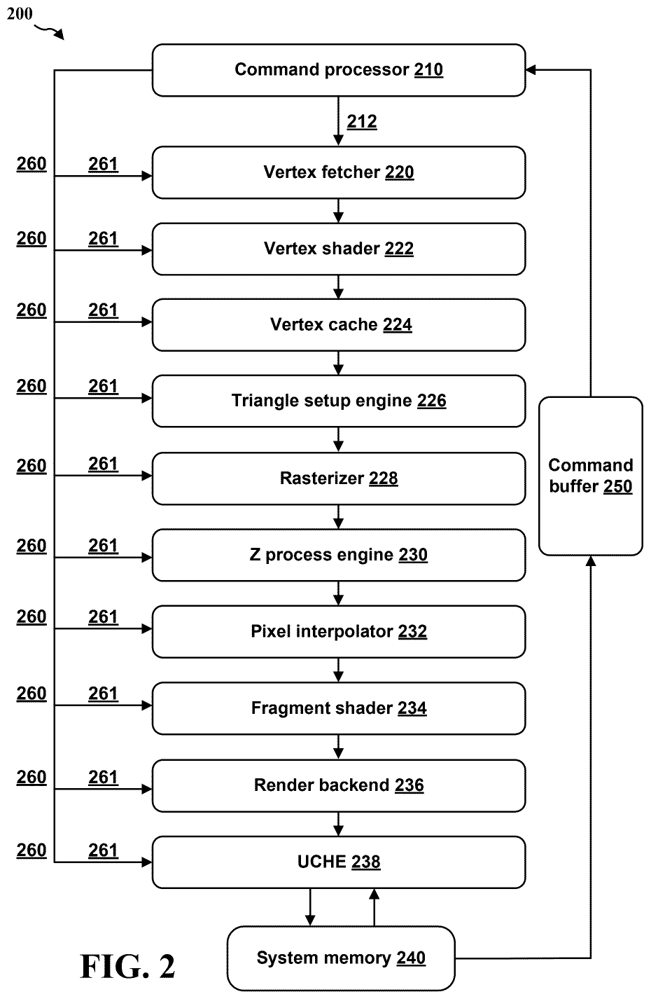

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

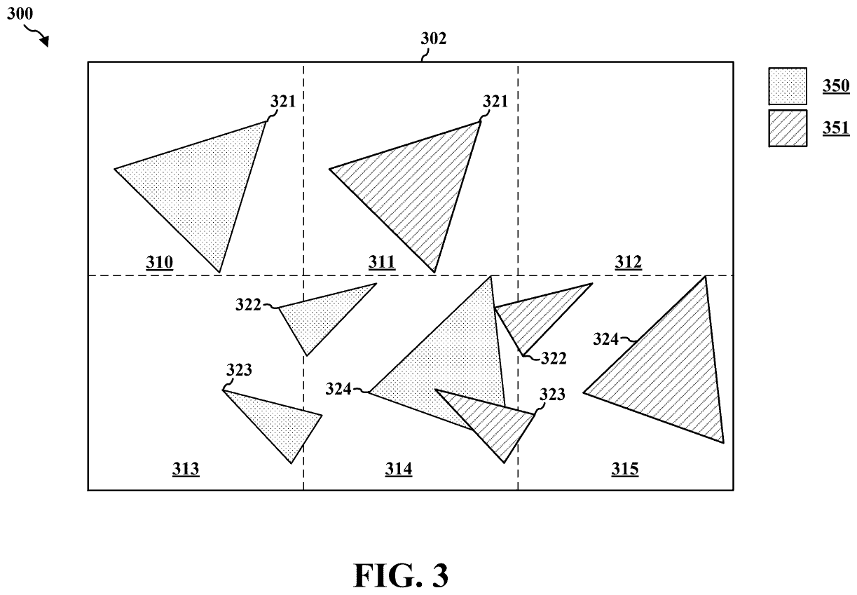

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

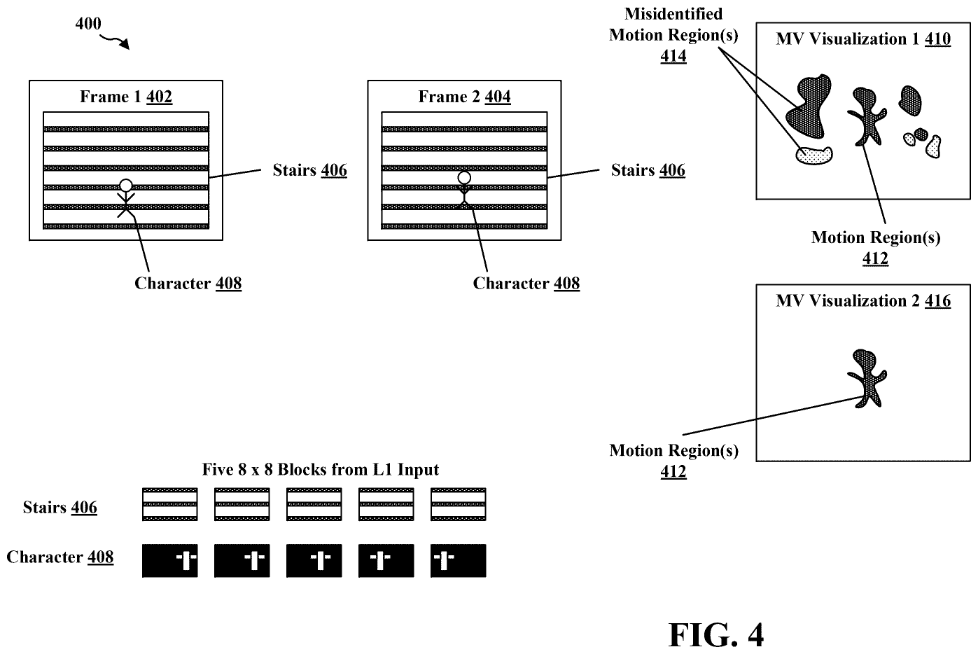

FIG. 4 is a diagram 400 illustrating example aspects of motion estimation (ME) in accordance with one or more techniques of this disclosure. ME (which may also be referred to as an ME process) may refer to a process of determining motion vectors that describe a transformation from a first image to a second image (e.g., successive two-dimensional (2D) frames in a video sequence). The motion vectors may relate to a whole image (i.e., global motion estimation) or to specific parts of an image, such as rectangular blocks, arbitrary shaped patches, or pixels. ME may be used to interpolate motion between frames and/or to extrapolate motion for future frames.

An ME process may be a full search ME process, a heuristic based ME process, or a hierarchical ME process. In a full search ME process, each block of pixels in a first frame may be compared to each block of pixels in a second frame to find a match between the first frame and the second frame and a corresponding motion vector describing the motion between the first frame and the second frame. In a heuristic based ME process, selected number(s) of pixel blocks may be compared to initial block(s) based on assumptions of a form of a vector field. A full search ME process may produce high quality results, that is, the full search ME process may generate motion vectors that accurately describe motion from a first frame to a second frame. However, the full search ME process may be computationally intensive. A heuristic based ME process may be less computationally intensive to execute compared to a full search ME process. However, the heuristic based ME process may generate lower quality results compared to results generated by a full search ME process, that is results generated by the heuristic based ME process may less accurately describe motion from the first frame to the second frame compared to results generated by the full search ME process.

In a hierarchical ME process, a device (e.g., the device 104) may generate an image pyramid based on a first image and a second image (e.g., successive video frames). With more particularity, the pyramid of images may include levels having different resolutions and sizes. A resolution may refer to a level of detail of an image or a level of detail of results of a DFS pass or an ME pass. In an example, a low level (e.g., level 1 (L1)) of the image pyramid may correspond to a reduced size and resolution of an initial image (e.g., the first image, the second image), a next level (e.g., level 2 (L2)) of the image pyramid may correspond to an increase in the size and resolution of the image compared to L1, and a next level (e.g., level 3 (L3)) of the image pyramid may correspond to a further increase in the size and resolution compared to L2. In an example, the device may generate the image pyramid via a mean intensity metric or subsampling. After generation of the image pyramid, the device may locate a corresponding lower level block (i.e., a lower level pixel block) for each block (i.e., pixel block) of the first frame. The device may then perform a search in a lower level of the first frame and second frame. For instance, the device may define a search window in the second frame and each block in the first frame (e.g., at L2) may be evaluated for candidate motion vectors in the second frame (e.g., at L1). A search window may refer to a number of pixel blocks that are searched for a match between a first image and a second image. The search may be based on a measure of block difference, such as a mean absolute difference (MAD) or a mean square difference (MSD). This process may be repeated for each consecutive level of the image pyramid until a last level (i.e., a highest resolution level) of the image pyramid is reached to produce a final motion vector. The hierarchical ME process may offer low computational complexity, high efficiency, and a large degree of flexibility compared to a full search ME process or a heuristic based ME process. In a hierarchical ME process, performing a search at a level may be referred to as an ME pass. If the search is not a final search, results for the search may be referred to as partial ME results. In a hierarchical DFS process, performing a search at a level may be referred to as a DFS pass. If the search is not a final search, results for the search may be referred to as partial DFS results.

When performing an ME process, there may be characteristics in input content (i.e., a first frame and a second frame) which may introduce errors into vectors generated by the ME process. The characteristics may include repeating pattern(s) in the input content, flat/featureless region(s), and/or aperture issues (i.e., content where a limited search range or a limited block size causes more than one point along a line to match equally well between a first frame and a second frame). If such characteristics are present in input content in a hierarchical ME process, errors may be introduced at an early stage in the ME process. The errors may be difficult to remove. As such, the errors may be propagated to subsequent passes (i.e., stages) of the ME process and may persist in a final motion vector produced by the ME process.

In an example, a device (e.g., the device 104) may render a first frame 402 and a second frame 404, where the first frame 402 and the second frame 404 are successive frames in video content. A frame may refer to an image that is presented in a sequence of images as part of video content, an image that is captured with a camera, or an image that is rendered by a GPU. The first frame 402 may include a character 408 (e.g., a video game character) and stairs 406 at a first time instance. The second frame 404 may include the character 408 and the stairs 406 at a second time instance that occurs after the first time instance. Thus, the first frame 402 and the second frame 404 may reflect the character 408 walking up the stairs 406.

The first frame 402 and the second frame 404 may include content with characteristics that may introduce errors into an ME process. For instance, the first frame 402 and the second frame 404 may include repeating patterns (e.g., the stairs 406), flat/featureless regions (e.g., the stairs 406), and/or aperture issues (e.g., which may be associated with the stairs 406). For instance, the diagram 400 depicts five 8×8 pixel blocks from an L1 input to an ME process. As depicted, the 8×8 pixel blocks for the stairs 406 may be difficult to distinguish due to the aforementioned characteristics; however, the 8×8 pixel blocks for the character 408 may be able to be distinguished.

The content with the aforementioned characteristics may introduce errors into an ME process, that is, the aforementioned characteristics may cause the ME process to generate motion vectors that do not accurately describe motion between the first frame 402 and the second frame 404. For instance, when the ME process is a hierarchical ME process, the errors may be propagated to each level/pass of the ME process, which may affect a quality of a final motion vector output by the ME process. The diagram 400 depicts a first motion vector (MV) visualization 410 corresponding to the first frame 402 and the second frame 404 after a hierarchical ME process is performed on the first frame 402 and the second frame 404. The first MV visualization 410 may include motion region(s) 412 that are associated with motion between the first frame 402 and the second frame 404. For instance, the motion region(s) 412 may correspond to the character 408 as the character 408 walks up the stairs 406. The first MV visualization 410 may also include misidentified motion region(s) 414 that are associated with misidentified motion. For instance, the misidentified motion region(s) 414 may be indicative of motion when there is no motion, no motion when there is motion, and/or motion in an incorrect direction. In an example, the misidentified motion region(s) 414 may indicate than an ME process (e.g., a hierarchical ME process) has identified regions to the side of the character 408 as moving; however, as shown in the diagram 400, the stairs 406 on the side of the character may not move between the first frame 402 and the second frame 404. Aspects presented herein pertain to removing/mitigating errors early in a hierarchical ME process. For instance, using the technologies described herein, a device may perform an enhanced hierarchical ME process that may result in a second MV visualization 416 that (correctly) includes the motion region(s) 412 while not including the misidentified motion region(s) 414.

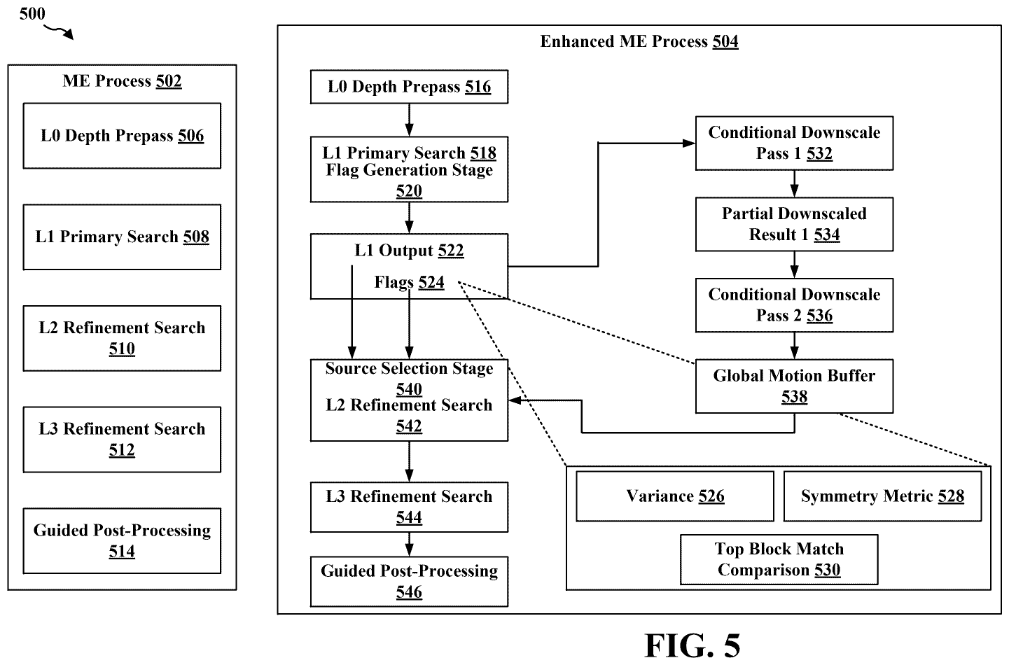

FIG. 5 is a diagram 500 illustrating examples of an ME process 502 and an enhanced ME process 504 in accordance with one or more techniques of this disclosure. The ME process 502 and the enhanced ME process 504 may also be referred to as a hierarchical ME process and an enhanced hierarchical ME process, respectively. The ME process 502 and/or the enhanced ME process 504 may be performed by the device 104. As will be described in greater detail below, the enhanced ME process 504 may be associated with removing errors relatively early in a DFS process, where the errors may be caused by repeating patterns in a first image and a second image, flat/featureless content in the first image and the second image, and/or aperture issues associated with the first image and the second image. The enhanced ME process 504 may be an in-line process.

The ME process 502 may include a level 0 (L0) depth prepass 506, a level 1 (L1) primary search 508, a level 2 (L2) refinement search 510, a level 3 (L3) refinement search 512, and guided post-processing 514. The device may perform the L0 depth prepass 506, the L1 primary search 508, the L2 refinement search 510, the L3 refinement search 512, and the guided post-processing 514 sequentially. In the L0 depth prepass 506, the device may identify region(s) of the first frame 402 and the second frame 404 that do not include motion. The L0 depth prepass may utilize a depth mask to be applied during subsequent processing. In the L1 primary search 508, the device may match first pixel blocks between the first frame 402 and the second frame 404 to generate first candidate motion vectors that are indicative of potential motion between the first frame 402 and the second frame 404. In the L2 refinement search 510, the device may match second pixel blocks between the first frame 402 and the second frame 404 based on the first candidate motion vectors in order to generate second candidate motion vectors that are indicative of potential motion between the first frame 402 and the second frame 404. The second pixel blocks may be a subset of the first pixel blocks. A first number of the first candidate motion vectors may be greater than a second number of the second candidate motion vectors. In the L3 refinement search 512, the device may match third pixel blocks between the first frame 402 and the second frame 404 based on the second candidate motion vectors in order to generate third candidate motion vectors that are indicative of potential motion between the first frame 402 and the second frame 404. The third pixel blocks may be a subset of the second pixel blocks. The second number of the second candidate motion vectors may be greater than a third number of the third candidate motion vectors. In the guided post-processing 514, the device may perform guided filtering on the third candidate motion vectors to generate final motion vectors, where the final motion vectors may be indicative of motion between the first frame 402 and the second frame 404. Guided filtering may refer to an edge-preserving smoothing image filter.

If the first frame 402 and/or the second frame 404 include features with certain characteristics (e.g., repeated patterns, featureless regions, aperture issues), errors may be introduced into the ME process 502. For instance, if an error is introduced during the L1 primary search 508, the error may be propagated to later stages of the ME process 502 (e.g., the L2 refinement search, the L3 refinement search, etc.). The error may affect a quality of the final motion vectors. For instance, the errors may be associated with misidentified motion between the first frame 402 and the second frame 404. As described below, the enhanced ME process 504 may remove or mitigate errors caused by characteristics of the first frame 402 and/or the second frame 404 in order to produce higher quality motion vectors compared to motion vectors produced by the ME process 502.

The enhanced ME process 504 may include an L0 depth prepass 516. The L0 depth prepass 516 may be similar or identical to the L0 depth prepass 506. The enhanced ME process 504 may include an L1 primary search 518 that is based on results from the L0 depth prepass 516. The L1 primary search 518 may be similar or identical to the L1 primary search 508. The L1 primary search 518 may generate an L1 output 522. The L1 output 522 may include candidate motion vectors that potentially describe motion between the first frame 402 and the second frame 404.

The enhanced ME process 504 may include a flag generation stage 520 that generates flags 524, where the flags 524 may be indicative of error regions in the first frame 402 and/or the second frame 404. The error regions may be regions associated with misidentified motion, such as the misidentified motion region(s) 414. The device may perform the flag generation stage 520 based on (1) the L1 output 522 and (2) a set of metrics 526-530. The set of metrics 526-530 may be calculated/performed over L1 search window block matches (i.e., the L1 output 522). A block match may refer to a first set of pixels in a first frame that is matched to a second set of pixels in a second frame. The flag generation stage 520 may be performed in-line while performing the L1 primary search 518 in order to flag certain motion vectors that may be associated with misidentified motion region(s), such as the misidentified motion region(s) 414.

The set of metrics 526-530 may include a variance 526 between a set of top block matches between the first frame 402 and the second frame 404. The device may compute the variance 526 based on the set of top block matches. As used herein, variance may refer to an expected value of a squared deviation from a mean of a random variable associated with a set of block matches. In an example, the set of top block matches may be associated with five candidate motion vectors for describing motion between the first frame 402 and the second frame 404. In an example, the set of top block matches may be associated with a lowest five sum of squared difference (SSD) scores amongst a plurality of SSD scores. The variance 526 may be used as a measure of a gradient strength (i.e., a gradient strength metric) within a search window of the L1 primary search 518. The variance 526 may enable detection of featureless regions of the first frame 402 and the second frame 404 and/or detection of regions of poor differentiation for block matches between the first frame 402 and the second frame 404. Stated differently, the variance 526 may be computed in order to detect regions of the first frame 402 and the second frame 404 that are associated with a match confidence that is below a threshold confidence (i.e., the variance may be computed to detect low confidence regions associated with the first frame 402 and/or the second frame 404). In an example, the variance 526 may enable detection of the stairs 406.

The set of metrics 526-530 may include a symmetry metric 528. The symmetry metric 528 may also be referred to as an X/Y ratio, a gradient symmetry metric, or an X/Y symmetry metric. The device may compute the symmetry metric 528 based on the set of top block matches. The symmetry metric 528 may be a measure of symmetry of a search window gradient in a local region around a candidate block match between the first frame 402 and the second frame 404. The symmetry metric 528 may enable detection of aperture issues (i.e., content in which a limited search range or block size causes many points along a line to match equally well). In an example, the symmetry metric 528 may enable detection of the stairs 406. In an example, the symmetry metric 528 may be associated with a symmetry between a horizontal neighborhood block score vs. a vertical neighbor block score. In the example, the device may compute the symmetry metric 528 according to the following pseudocode listed below.

float vert=(abs(ssdCenter−ssdUp)+abs(ssdCenter−ssdDown))/2.0f;

float horiz=(abs(ssdCenter−ssdLeft)+abs(ssdCenter−ssdRight))/2.0f;

float ratio=abs(vert−horiz)/max(vert,horiz);

In the pseudocode above, “float” and “f” may refer to a floating point number. “Abs” may refer to an absolute value. “Ssd” may refer to a sum of square differences. “Max” may refer to a maximum. As used herein, “float horiz” may refer to a horizontal neighbor block score and “float vert” may refer to a vertical neighbor block score. In an example, the symmetry metric 528 may be or include “float ratio.”

The set of metrics 526-530 may include a top block match comparison 530 (which may also be referred to as “a comparison”). The top block match comparison 530 may also be referred to as “top-2 separation.” The device may perform the top block match comparison 530 based on the top two block matches (i.e., a first block match and a second block match) from the L1 primary search 518. The device may compare a first location of the first block match and a second location of the second block match. If, based on the comparison, the first location and the second location are not co-located (i.e., in the same position) or are not contiguous (i.e., not adjacent to one another), the first location and the second location may be associated with an error region of the first frame 402 and/or the second frame 404. If, based on the comparison, the first location and the second location are co-located or are contiguous, the first location and the second location may not be associated with an error region. The top block match comparison 530 may enable detection of repeating patterns in the first frame 402 and the second frame 404. In an example, the top block match comparison 530 may enable detection of the stairs 406.

The enhanced ME process 504 may include a set of conditional downscale passes. In an example, the set of conditional downscale passes may include a first conditional downscale pass 532 and a second conditional downscale pass 536. The set of conditional downscale passes may also include one downscale pass or greater than two downscale passes. The device may perform the set of conditional downscale passes based on (1) the L1 output 522 (i.e., partial ME results) and (2) the flags 524 identified during the flag generation stage 520. The set of conditional downscale passes may be an iterative set of conditional downscale passes (i.e., a set of iterative downscale passes), where each downscale pass in the iterative set of conditional downscale passes may be at a lower resolution than a resolution of a prior pass, and where each downscale pass other than a first downscale pass may utilize results of a previous downscale pass.

As noted above, the device may perform the first conditional downscale pass 532, where the first conditional downscale pass generates a first partial downscaled result 534. In an example, the device may perform the first conditional downscale pass based on averaging motion vectors for groups of pixels (e.g., groups of adjacent pixels, such as a rectangular group of pixels) of the first frame 402 and the second frame 404. For instance, the motion vectors may include a first motion vector for a first pixel in the group of pixels, a second motion vector for a second pixel in the group of pixels, a third motion vector for a third pixel in the group of pixels, and a fourth motion vector for a fourth pixel in the group of pixels. In an example, the flags 524 may include a flag that indicates that the fourth motion vector is associated with an error region of the first frame 402 and/or the second frame 404. In the example, based on the flag, the device may average the first motion vector, the second motion vector, and the third motion vector (and not the fourth motion vector) to generate a motion vector in the first partial downscaled result 534. Thus, the device may “erode” (i.e., mitigate or reduce) flagged regions (i.e., error regions) of the first frame 402 and/or the second frame 404 by not including motion vectors corresponding to the flagged regions in the computation of the set of downscale passes.

The device may also perform the second conditional downscale pass 536 in a manner similar to that of the first conditional downscale pass 532, where the second conditional downscale pass 536 may be based on the first partial downscaled result 534. The device may then generate a global motion buffer 538 based on the set of conditional downscale passes (e.g., the first conditional downscale pass 532 and the second conditional downscale pass 536). The global motion buffer 538 may represent a “coarse” level of motion between an entirety of the first frame 402 and the second frame 404. For instance, the L1 output 522 may be indicative of motion of specific regions of the first frame 402 and the second frame 404, whereas the global motion buffer 538 may be indicative of an overall motion between the first frame 402 and the second frame 404. The global motion buffer 538 may be at a lower resolution than a resolution of the first partial downscaled result 534.

The enhanced ME process 504 may include a source selection stage 540 and an L2 refinement search 542. In general, at the source selection stage 540, the device may select, as an input for the L2 refinement search 542, (1) a motion vector from the global motion buffer 538, (2) a motion vector from the L1 output 522, or (3) a representative value computed from the motion vector from the global motion buffer 538 and the motion vector from the L1 output 522. The device may then perform the L2 refinement search 542 with the selected input in a manner similar to that described above for the L2 refinement search 512. Stated differently, the L1 output 522 (i.e., intermediate results from an initial motion search), the flags 524 (i.e., flagged motion vector information identified by the set of metrics 526-530), and the global motion buffer 538 may be combined at a top of the L2 refinement search 542 (i.e., a following refinement ME pass) in order to remove motion vectors associated with error regions (i.e., error vectors) in-line and early in the enhanced ME process 504. The L2 refinement search 512 may be associated with an input median filter. The device may then perform an L3 refinement search 544 and guided post-processing 546 in a manner similar to or identical to the L3 refinement search 512 and the guided post-processing 514, respectively, where the guided post-processing 514 may output final motion vectors that describe motion between the first frame 402 and the second frame 404. Removing the error vectors in the aforementioned manner may cause the enhanced ME process 504 to operate on “clean” data with eliminated errors. Thus, the enhanced ME process 504 may generate a higher quality final motion vector compared to a final motion vector generated by the ME process 502, that is, a final motion vector generated by the enhanced ME process 504 may more accurately describe motion between the first frame 402 and the second frame 404 compared to a motion vector generated by the ME process 502.

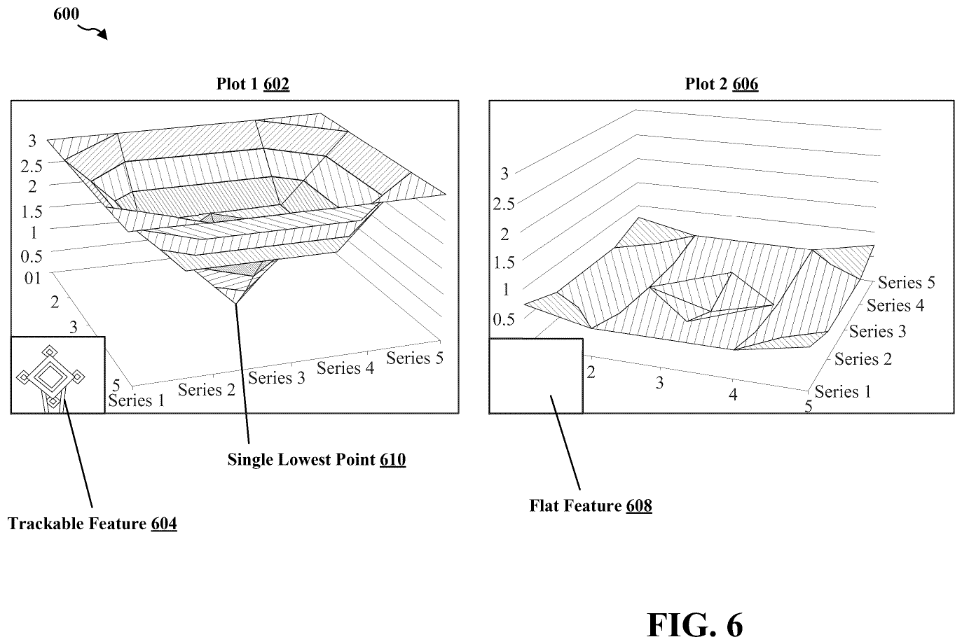

FIG. 6 is a diagram 600 illustrating example aspects pertaining to metrics used for identifying error regions in an ME process in accordance with one or more techniques of this disclosure. The diagram 600 depicts a first plot 602 for a trackable feature 604 and a second plot 606 for a flat feature 608. The first plot 602 and the second plot 606 may be based on SSD scores.

In an example, the trackable feature 604 may be or include the character 408 or a region associated with the character 408. The first plot 602 may include a single lowest point 610. As such, the first plot 602 may be associated with a relatively high confidence of a match between the first frame 402 and the second frame 404 for the trackable feature 604. In an example, the flat feature 608 may be or include the stairs 406 or a region of the stairs 406. As described above, flat/featureless regions in an image may introduce errors into an ME process. As such, the second plot 606 may not have a single, well-defined lowest point. Thus, the second plot 606 may be associated with a relatively low confidence of a match between the first frame 402 and the second frame 404 for the flat feature 608.

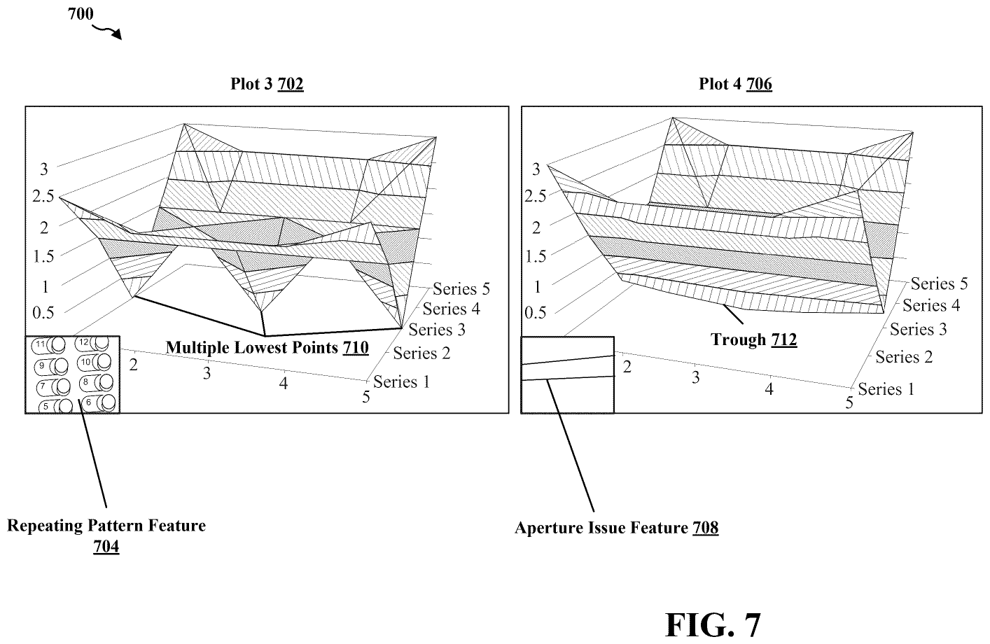

FIG. 7 is a diagram 700 illustrating further example aspects pertaining to metrics used for identifying error regions in an ME process in accordance with one or more techniques of this disclosure. The diagram 700 depicts a third plot 702 for a repeating pattern feature 704 and a fourth plot 706 for an aperture issue feature 708. The third plot 702 and the fourth plot 706 may be based on SSD scores.

In an example, the repeating pattern feature 704 may be or include the stairs 406 or a region of the stairs 406. As described above, repeated patterns in an image may introduce errors into an ME process. The third plot 702 may include multiple lowest points 710. Thus, the third plot 702 may be associated with a relatively low confidence of a match between the first frame 402 and the second frame 404 for the repeating pattern feature 704. In an example, the aperture issue feature 708 may be or include the stairs 406 or a region of the stairs 406. As described above, aperture issues in an image may introduce errors into an ME process. The fourth plot 706 may include a trough 712. Thus, the fourth plot 706 may be associated with a relatively low confidence of a match between the first frame 402 and the second frame 404 for the aperture issue feature 708.

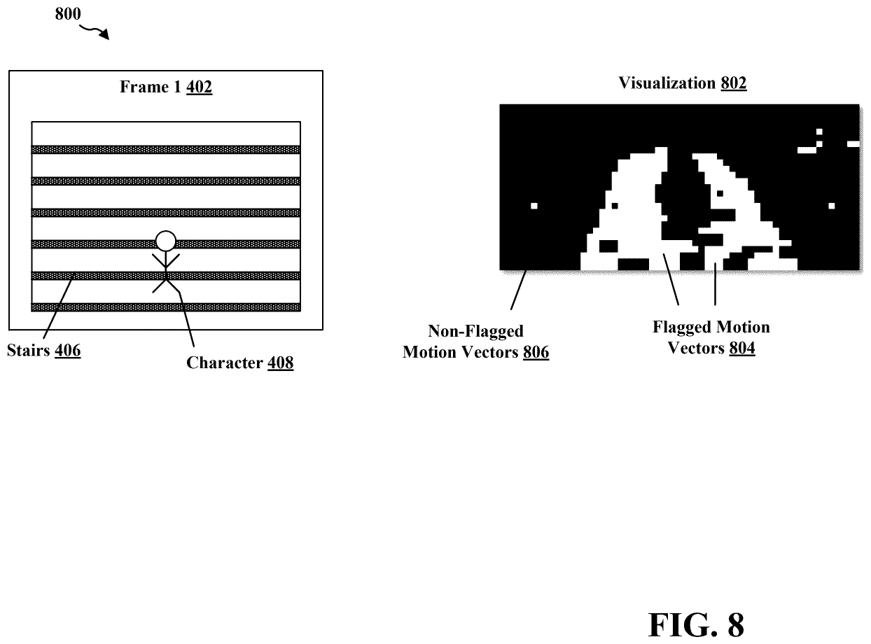

FIG. 8 is a diagram 800 illustrating example aspects pertaining to flagging error regions in accordance with one or more techniques of this disclosure. The diagram 800 depicts the first frame 402, the stairs 406, and the character 408. The diagram 800 also depicts a visualization 802. The visualization 802 may represent flagged motion vectors 804 (indicated in the visualization 802 by white coloring) and non-flagged motion vectors 806 (indicated in the visualization 802 by black coloring). In an example, the flagged motion vectors 804 may correspond to the flags 524 generated by the flag generation stage 520. The flagged motion vectors 804 may correspond to the misidentified motion region(s) 414.

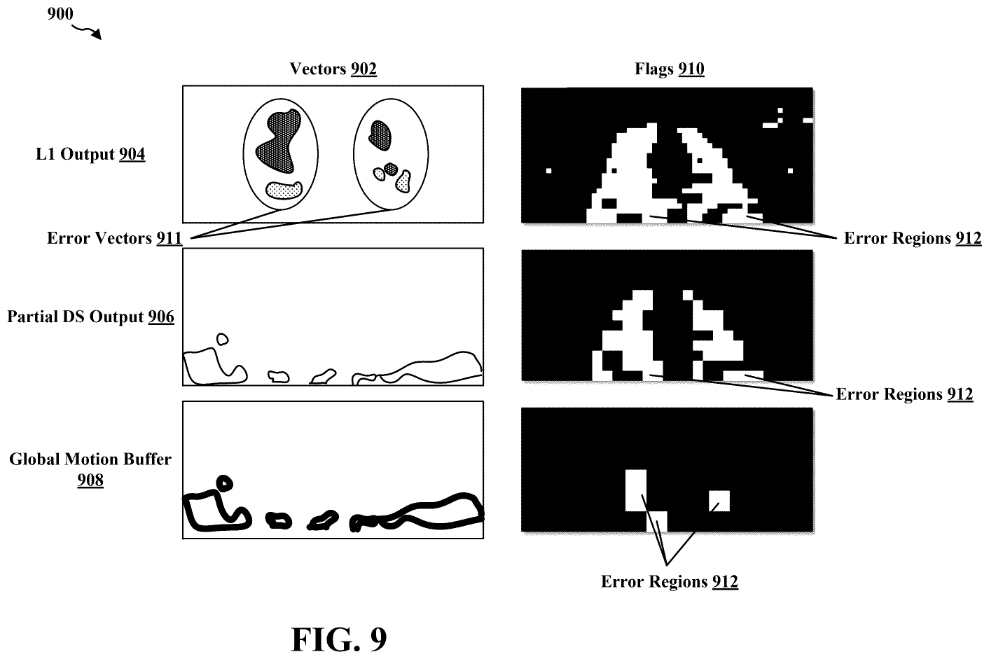

FIG. 9 is a diagram 900 illustrating example aspects pertaining to downscale passes and a global motion buffer in accordance with one or more techniques of this disclosure. The diagram 900 depicts vectors 902 (i.e., motion vectors) for an L1 output 904, a partial downscaled (DS) output 906, and a global motion buffer 908. The diagram 900 also depicts flags 910 for the L1 output 904, the partial DS output 906, and the global motion buffer 908. The L1 output 904 may include error vectors 911, where the error vectors 911 may correspond to the misidentified motion region(s) 414. In an example, the L1 output 904 may be or include the L1 output 522, the partial DS output 906 may be or include the first partial downscaled result 534, and the global motion buffer 908 may be or include the global motion buffer 538. The diagram 900 also depicts error regions 912 associated with the flags 910 for the L1 output 904, the partial DS output 906, and the global motion buffer 908. In an example, the L1 output 904 may be at a first resolution, the partial DS output 906 may be at a second resolution, and the global motion buffer 908 may be at a third resolution, where the first resolution is greater than the second resolution, and where the second resolution is greater than the third resolution. As depicted in the diagram 900, a size of the error regions 912 may be reduced as the set of conditional downscale passes is performed. Thus, a device may “erode” (i.e., mitigate or reduce) the error regions 912 by performing the set of conditional downscale passes and generating the global motion buffer 908.

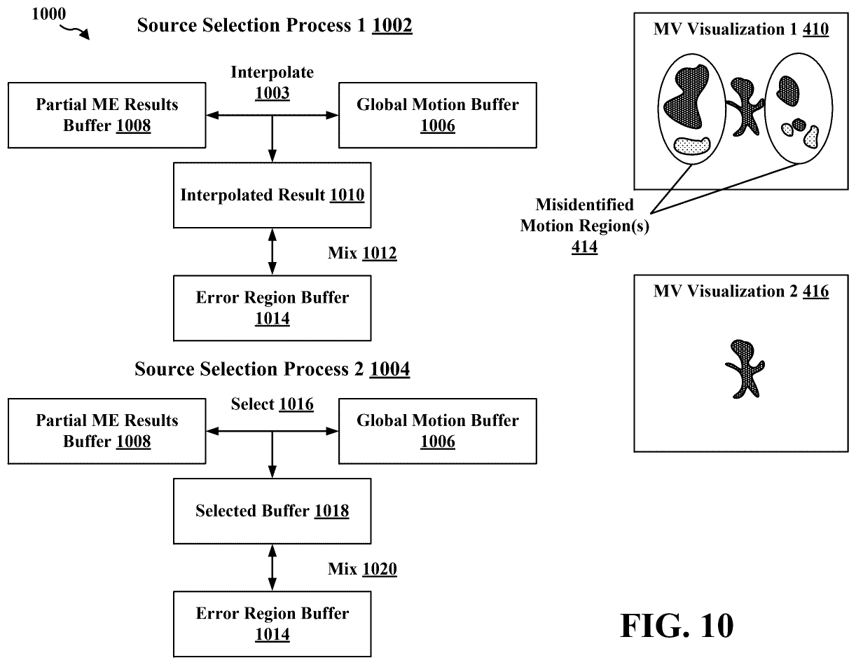

FIG. 10 is a diagram 1000 illustrating example aspects pertaining to source selection for an ME process in accordance with one or more techniques of this disclosure. The diagram 1000 depicts a first source selection process 1002 and a second source selection process 1004. The first source selection process 1002 and the second source selection process 1004 may be associated with or may be included in the source selection stage 540.

In the first source selection process 1002, at 1003, a device (e.g., the device 104) may interpolate (e.g., linearly interpolate) between motion vector(s) in a global motion buffer 1006 and motion vector(s) in a partial ME results buffer 1008. In an example, the global motion buffer 1006 may be or include the global motion buffer 538 and the partial ME results buffer 1008 may be or include the L1 output 522. The interpolation may generate an interpolated result 1010, where the interpolated result 1010 may include interpolated motion vector(s). At 1012, the device may mix the interpolated result 1010 with motion vector(s) (e.g., flag values) in an error region buffer 1014. In an example, the device may bilinearly sample the error region buffer 1014 and the device may then perform the mixing at 1012 based on the (bilinearly sampled) error region buffer 1014. The error region buffer 1014 may be or include the flags 524. The device may then perform a refinement pass (e.g., the L2 refinement search 542) based on the (mixed) interpolated result 1010. A refinement pass may refer to a pass of an ME process or a DFS process that refines an output of a previous pass of the ME process or the DFS process.

In the second source selection process, at 1016, the device may select between the motion vector(s) in the global motion buffer 1006 and the motion vector(s) in the partial ME results buffer 1008. For instance, for each pixel or pixel block in the first frame 402 and the second frame 404, the device may determine whether a pixel or a pixel block is identified/indicated by the flags 524. If the pixel/pixel block is identified/indicated by the flags 524, at 1016, the device may select the global motion buffer 1006. If the pixel/pixel block is not indicated/identified by the flags 524, at 1016, the device may select the partial ME results buffer 1008. At 1020, the device may mix motion vector(s) in a selected buffer 1018 (e.g., the partial ME results buffer 1008 or the global motion buffer 1006) with motion vector(s) (e.g., flag values) in the error region buffer 1014. In an example, the device may bilinearly sample the error region buffer 1014 and the device may then perform the mixing at 1020 based on the (bilinearly sampled) error region buffer 1014. The device may then perform a refinement pass (e.g., the L2 refinement search 542) based on the (mixed) selected buffer 1018.

The diagram 1000 further depicts the first MV visualization 410 and the second MV visualization 416. In an example, the first MV visualization 410 may correspond to an output of the ME process 502 and the second MV visualization 416 may correspond to an output of the enhanced ME process 504. As illustrated in the diagram 1000, the second MV visualization 416 does not include the misidentified motion region(s) 414. Thus, as reflected in the second MV visualization 416, the enhanced ME process 504 may remove corrupted regions from a hierarchical ME process.

Although the above-described technologies have been described in the context of a hierarchical ME process, it is to be understood that the above-described technologies may also be applicable to a hierarchical DFS process.

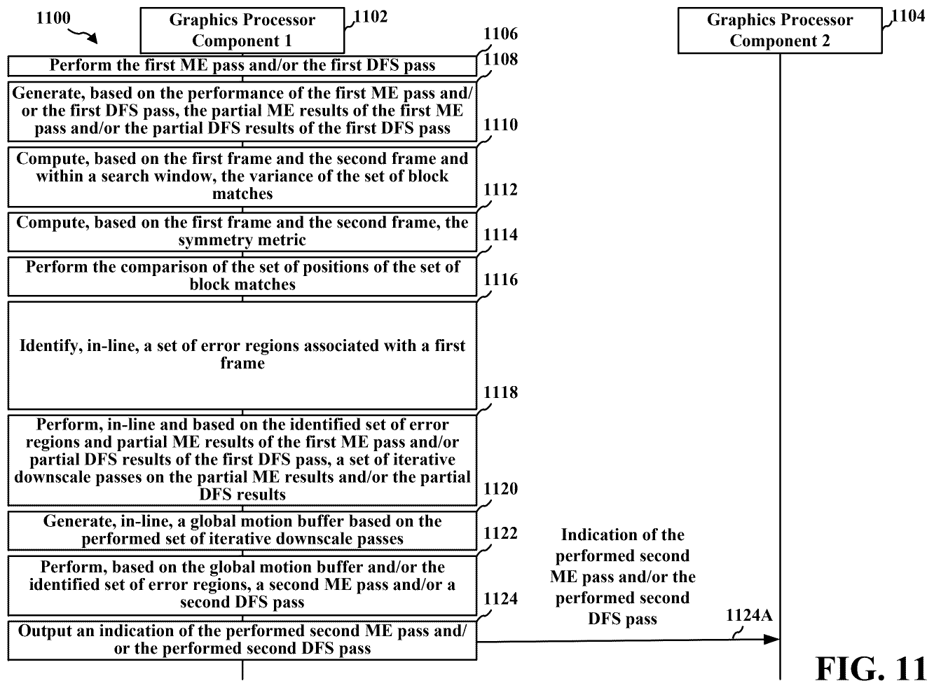

FIG. 11 is a call flow diagram 1100 illustrating example communications between a first graphics processor component 1102 and a second graphics processor component 1104 in accordance with one or more techniques of this disclosure. In an example, the first graphics processor component 1102 and/or the second graphics processor component 1104 may be included in the device 104. In an example, the first graphics processor component 1102 may be a shader processor that executes a shader.

At 1116, the first graphics processor component 1102 may identify, in-line, a set of error regions associated with a first frame. At 1118, the first graphics processor component 1102 may perform, in-line and based on the identified set of error regions and at least one of partial ME results of a first ME pass or partial DFS results of a first DFS pass, a set of iterative downscale passes on at least one of the partial ME results or the partial DFS results. At 1120, the first graphics processor component 1102 may generate, in-line, a global motion buffer based on the performed set of iterative downscale passes. At 1122, the first graphics processor component 1102 may perform, based on at least one of the global motion buffer or the identified set of error regions, at least one of a second ME pass or a second DFS pass.

At 1124, the first graphics processor component 1102 may output (e.g., to/for the second graphics processor component 1104) an indication of at least one of the performed second ME pass or the performed second DFS pass. For instance, at 1124A, the first graphics processor component 1102 may transmit the indication of at least one of the performed second ME pass or the performed second DFS pass to the second graphics processor component 1104.

At 1106, the first graphics processor component 1102 may perform at least one of the first ME pass or the first DFS pass. At 1108, the first graphics processor component 1102 may generate, based on the performance of at least one of the first ME pass or the first DFS pass, at least one of the partial ME results of the first ME pass or the partial DFS results of the first DFS pass.

At 1110, the first graphics processor component 1102 may compute, based on the first frame and a second frame and within a search window, a variance of a set of block matches of at least one of the first ME pass or the first DFS pass for the first frame and the second frame. At 1112, the first graphics processor component 1102 may compute, based on the first frame and the second frame, a symmetry metric associated with the set of block matches. At 1114, the first graphics processor component 1102 may perform a comparison of a set of positions of the set of block matches, where identifying the set of error regions at 1116 may include identifying the set of error regions based on at least one of the computed variance, the computed symmetry metric, or the performed comparison.

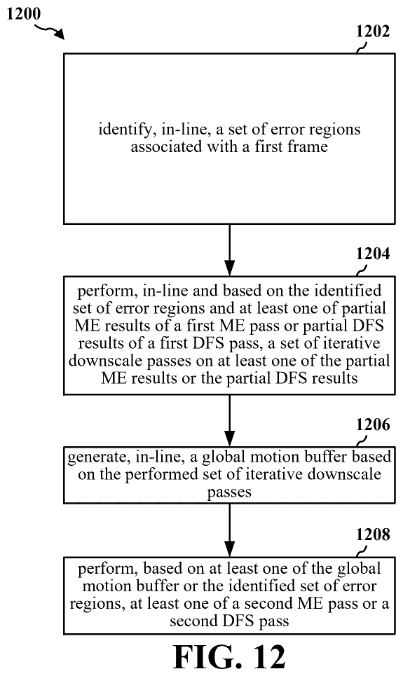

FIG. 12 is a flowchart 1200 of an example method of graphics processing in accordance with one or more techniques of this disclosure. The method may be performed by an apparatus, such as an apparatus for graphics processing, a GPU (e.g., the GPU 200), a CPU, a shader, a shader processor, the first graphics processor component 1102, the device 104, a wireless communication device, and the like, as used in connection with the aspects of FIGS. 1-11. The method may be associated with various advantages at the apparatus, such as eliminating or mitigating errors introduced into a hierarchical ME/DFS process by repeating patterns, featureless regions, and/or aperture issues. In an example, the method may be performed by the error corrector 198.

At 1202, the apparatus identifies, in-line, a set of error regions associated with a first frame. For example, FIG. 11 at 1116 shows that the first graphics processor component 1102 may identify, in-line, a set of error regions associated with a first frame. In an example, the set of error regions may correspond to the flagged motion vectors 804. In an example, the set of error regions may be or include the error regions 912. In an example, the first frame may be the first frame 402. In an example, the set of error regions may be associated with the second plot 606, the third plot 702, and/or the fourth plot 706. In an example, the first ME pass may be or include the L1 primary search 518. In an example, the set of error regions may be associated with the flags 524. In an example, 1202 may be performed by the error corrector 198.

At 1204, the apparatus performs, in-line and based on the identified set of error regions and at least one of partial ME results of a first ME pass or partial DFS results of a first DFS pass, a set of iterative downscale passes on at least one of the partial ME results or the partial DFS results. For example, FIG. 11 at 1118 shows that the first graphics processor component 1102 may perform, in-line and based on the identified set of error regions and at least one of partial ME results of a first ME pass or partial DFS results of a first DFS pass, a set of iterative downscale passes on at least one of the partial ME results or the partial DFS results. In an example, the set of iterative downscale passes may be or include the first conditional downscale pass 532 and/or the second conditional downscale pass 536. In an example, the partial ME results may be or include the L1 output 522. In an example, the set of iterative downscale passes may be associated with the partial DS output 906. In an example, 1204 may be performed by the error corrector 198.

At 1206, the apparatus generates, in-line, a global motion buffer based on the performed set of iterative downscale passes. For example, FIG. 11 at 1120 shows that the first graphics processor component 1102 may generate, in-line, a global motion buffer based on the performed set of iterative downscale passes. In an example, the global motion buffer may be or include the global motion buffer 538. In another example, the global motion buffer may be or include the global motion buffer 908. In an example, 1206 may be performed by the error corrector 198.

At 1208, the apparatus performs, based on at least one of the global motion buffer or the identified set of error regions, at least one of a second ME pass or a second DFS pass. For example, FIG. 11 at 1122 shows that the first graphics processor component 1102 may perform, based on at least one of the global motion buffer or the identified set of error regions, at least one of a second ME pass or a second DFS pass. In an example, the second ME pass may be or include the L2 refinement search 542. In an example, 1208 may be performed by the error corrector 198.

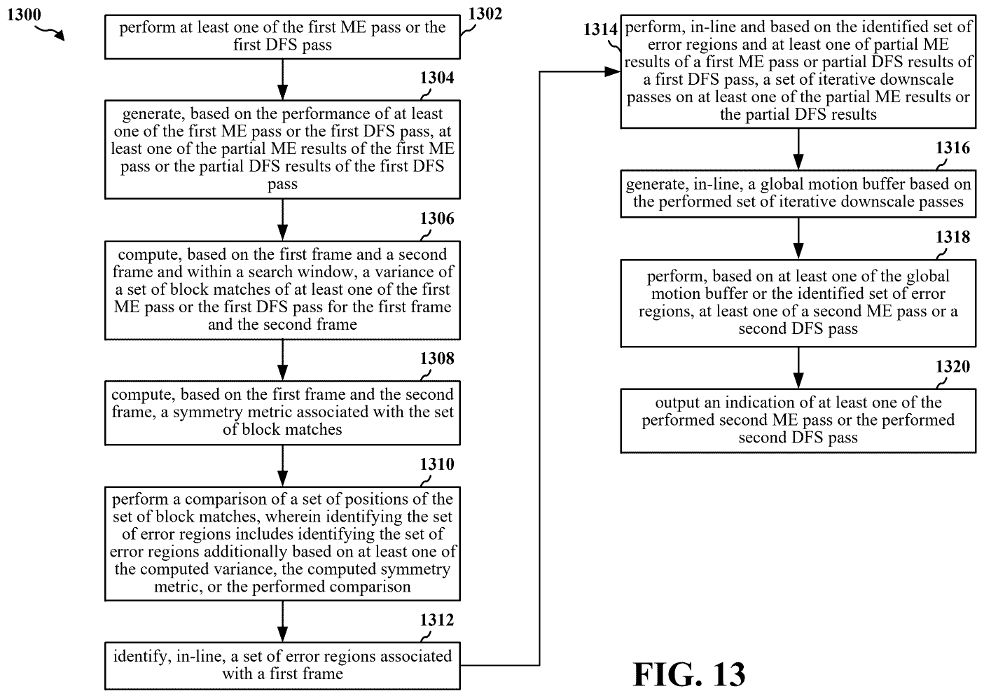

FIG. 13 is a flowchart 1300 of an example method of graphics processing in accordance with one or more techniques of this disclosure. The method may be performed by an apparatus, such as an apparatus for graphics processing, a GPU (e.g., the GPU 200), a CPU, a shader, a shader processor, the first graphics processor component 1102, the device 104, a wireless communication device, and the like, as used in connection with the aspects of FIGS. 1-11. The method may be associated with various advantages at the apparatus, such as eliminating or mitigating errors introduced into a hierarchical ME/DFS process by repeating patterns, featureless regions, and/or aperture issues. In an example, the method (including the various aspects detailed below) may be performed by the error corrector 198.

At 1312, the apparatus identifies, in-line, a set of error regions associated with a first frame. For example, FIG. 11 at 1116 shows that the first graphics processor component 1102 may identify, in-line, a set of error regions associated with a first frame. In an example, the set of error regions may correspond to the flagged motion vectors 804. In an example, the set of error regions may be or include the error regions 912. In an example, the first frame may be the first frame 402. In an example, the set of error regions may be associated with the second plot 606, the third plot 702, and/or the fourth plot 706. In an example, the first ME pass may be or include the L1 primary search 518. In an example, the set of error regions may be associated with the flags 524. In an example, 1312 may be performed by the error corrector 198.

At 1314, the apparatus performs, in-line and based on the identified set of error regions and at least one of partial ME results of a first ME pass or partial DFS results of a first DFS pass, a set of iterative downscale passes on at least one of the partial ME results or the partial DFS results. For example, FIG. 11 at 1118 shows that the first graphics processor component 1102 may perform, in-line and based on the identified set of error regions and at least one of partial ME results of a first ME pass or partial DFS results of a first DFS pass, a set of iterative downscale passes on at least one of the partial ME results or the partial DFS results. In an example, the set of iterative downscale passes may be or include the first conditional downscale pass 532 and/or the second conditional downscale pass 536. In an example, the partial ME results may be or include the L1 output 522. In an example, the set of iterative downscale passes may be associated with the partial DS output 906. In an example, 1314 may be performed by the error corrector 198.

At 1316, the apparatus generates, in-line, a global motion buffer based on the performed set of iterative downscale passes. For example, FIG. 11 at 1120 shows that the first graphics processor component 1102 may generate a global motion buffer based on the performed set of iterative downscale passes. In an example, the global motion buffer may be or include the global motion buffer 538. In another example, the global motion buffer may be or include the global motion buffer 908. In an example, 1316 may be performed by the error corrector 198.

At 1318, the apparatus performs, based on at least one of the global motion buffer or the identified set of error regions, at least one of a second ME pass or a second DFS pass. For example, FIG. 11 at 1122 shows that the first graphics processor component 1102 may perform, based on at least one of the global motion buffer or the identified set of error regions, at least one of a second ME pass or a second DFS pass. In an example, the second ME pass may be or include the L2 refinement search 542. In an example, 1318 may be performed by the error corrector 198.

In one aspect, at 1320, the apparatus may output an indication of at least one of the performed second ME pass or the performed second DFS pass. For example, FIG. 11 at 1124 shows that the first graphics processor component 1102 may output (e.g., to/for the second graphics processor component 1104) an indication of at least one of the performed second ME pass or the performed second DFS pass. In an example, 1320 may be performed by the error corrector 198.

In one aspect, outputting the indication of at least one of the performed second ME pass or the performed second DFS pass may include: transmitting the indication of at least one of the performed second ME pass or the performed second DFS pass; or storing, in at least one of a memory, a buffer, or a cache, the indication of at least one of the performed second ME pass or the performed second DFS pass. For example, outputting the indication of at least one of the performed second ME pass or the performed second DFS pass may include, at 1124A, transmitting the indication of at least one of the performed second ME pass or the performed second DFS pass. In another example, outputting the indication of at least one of the performed second ME pass or the performed second DFS pass at 1124 may include storing, in at least one of a memory, a buffer, or a cache, the indication of at least one of the performed second ME pass or the performed second DFS pass.

In one aspect, at 1302, the apparatus may perform at least one of the first ME pass or the first DFS pass. For example, FIG. 11 at 1106 shows that the first graphics processor component 1102 may perform at least one of the first ME pass or the first DFS pass. In an example, the first ME pass may be or include the L1 primary search 518. In an example, 1302 may be performed by the error corrector 198.

In one aspect, at 1304, the apparatus may generate, based on the performance of at least one of the first ME pass or the first DFS pass, at least one of the partial ME results of the first ME pass or the partial DFS results of the first DFS pass. For example, FIG. 11 at 1108 shows that the first graphics processor component 1102 may generate, based on the performance of at least one of the first ME pass or the first DFS pass, at least one of the partial ME results of the first ME pass or the partial DFS results of the first DFS pass. In an example, the partial ME results may be the L1 output 522. In an example, 1304 may be performed by the error corrector 198.

In one aspect, performing at least one of the second ME pass or the second DFS pass may include performing at least one of the second ME pass or the second DFS pass further based on at least one of the partial ME results of the first ME pass or the partial DFS results of the first DFS pass. For example, performing at least one of the second ME pass or the second DFS pass at 1122 may include performing at least one of the second ME pass or the second DFS pass further based on at least one of the partial ME results of the first ME pass or the partial DFS results of the first DFS pass.

In one aspect, performing at least one of the second ME pass or the second DFS pass may include: interpolating between (1) at least one of the partial ME results or the partial DFS results and (2) the global motion buffer to generate an interpolated result. For example, performing at least one of the second ME pass or the second DFS pass at 1122 may include: interpolating between (1) at least one of the partial ME results or the partial DFS results and (2) the global motion buffer to generate an interpolated result. In an example, the partial ME results may be associated with the partial ME results buffer 1008 and the global motion buffer may be or include the global motion buffer 1006. In an example, the interpolated result may be or include the interpolated result 1010. In an example, the aforementioned aspect may correspond to the first source selection process 1002.

In one aspect, performing at least one of the second ME pass or the second DFS pass may further include: sampling the identified set of error regions. For example, performing at least one of the second ME pass or the second DFS pass at 1122 may further include: sampling the identified set of error regions. In an example, sampling the identified set of error regions may include sampling the error region buffer 1014. Sampling the identified set of error regions may refer to selecting a set of error regions associated with a number of motion vectors. In an example, the aforementioned aspect may correspond to the first source selection process 1002.

In one aspect, performing at least one of the second ME pass or the second DFS pass may further include: mixing the sampled identified set of error regions with the interpolated result. For example, performing at least one of the second ME pass or the second DFS pass at 1122 may further include: mixing the sampled identified set of error regions with the interpolated result. In an example, the aforementioned aspect may correspond to the first source selection process 1002.

In one aspect, performing at least one of the second ME pass or the second DFS pass may include: selecting (1) at least one of the partial ME results or the partial DFS results or (2) the global motion buffer. For example, performing at least one of the second ME pass or the second DFS pass at 1122 may include: selecting (1) at least one of the partial ME results or the partial DFS results or (2) the global motion buffer. In an example, the aforementioned aspect may correspond to the second source selection process 1004.

In one aspect, performing at least one of the second ME pass or the second DFS pass may further include: sampling the identified set of error regions. For example, performing at least one of the second ME pass or the second DFS pass at 1122 may further include: sampling the identified set of error regions. In an example, sampling the identified set of error regions may include sampling the error region buffer 1014. In an example, the aforementioned aspect may correspond to the second source selection process 1004.

In one aspect, performing at least one of the second ME pass or the second DFS pass may further include: mixing the sampled identified set of error regions with (1) at least one of the selected partial ME results or the selected partial DFS results or (2) the selected global motion buffer. For example, performing at least one of the second ME pass or the second DFS pass at 1122 may further include: mixing the sampled identified set of error regions with (1) at least one of the selected partial ME results or the selected partial DFS results or (2) the selected global motion buffer. In an example, the aforementioned aspect may correspond to the second source selection process 1004.

In one aspect, the identification of the set of error regions, the performance of the set of iterative downscale passes, and the generation of the global motion buffer may be executed in-line as part of at least one of a hierarchical ME process or a hierarchical DFS process. For example, the hierarchical ME process may be or include the enhanced ME process 504.

In one aspect, the first ME pass or the first DFS pass may include an initial ME pass or an initial DFS pass, respectively, and the second ME pass or the second DFS pass may include a refinement ME pass or a refinement DFS pass, respectively. For example, the initial ME pass may be or include the L1 primary search 518 and the refinement ME pass may be or include the L2 refinement search 542.

In one aspect, at least one of the partial ME results or the partial DFS results may include a first resolution, and the global motion buffer may include a second resolution that is less than the first resolution. For example, the L1 output 522 may include a first resolution and the global motion buffer 538 may include a second resolution that is less than the first resolution. In another example, the L1 output 904 may include a first resolution and the global motion buffer 908 may include a second resolution that is less than the first resolution.

In one aspect, performing the set of iterative downscale passes on at least one of the partial ME results or the partial DFS results may include: discarding a first set of motion vectors associated with at least one of the first frame or a second frame, where the first set of motion vectors may correspond to the identified set of error regions. For example, performing the set of iterative downscale passes on at least one of the partial ME results or the partial DFS results at 1118 may include: discarding a first set of motion vectors associated with at least one of the first frame or the second frame, where the first set of motion vectors may correspond to the identified set of error regions. In an example, the second frame may be the second frame 404.

In one aspect, performing the set of iterative downscale passes on at least one of the partial ME results or the partial DFS results may further include: replacing the first set of motion vectors with a second set of motion vectors, where generating the global motion buffer may include generating the global motion buffer with the second set of motion vectors and without the first set of motion vectors. For example, performing the set of iterative downscale passes on at least one of the partial ME results or the partial DFS results at 1118 may further include: replacing the first set of motion vectors with a second set of motion vectors, where generating the global motion buffer at 1120 may include generating the global motion buffer with the second set of motion vectors and without the first set of motion vectors.

In one aspect, at 1306, the apparatus may compute, based on the first frame and a second frame and within a search window, a variance of the set of block matches of at least one of the first ME pass or the first DFS pass for the first frame and the second frame. For example, FIG. 11 at 1110 shows that the first graphics processor component 1102 may compute, based on the first frame and a second frame and within a search window, a variance of the set of block matches of at least one of the first ME pass or the first DFS pass for the first frame and the second frame. In an example, the variance may be the variance 526. In an example, the search window may be five 8×8 pixel blocks. In an example, the second frame may be the second frame 404. In an example, 1306 may be performed by the error corrector 198.

In one aspect, at 1308, the apparatus may compute, based on the first frame and the second frame, a symmetry metric associated with the set of block matches. For example, FIG. 11 at 1112 shows that the first graphics processor component 1102 may compute, based on the first frame and the second frame, a symmetry metric associated with the set of block matches. In an example, the symmetry metric may be or include the symmetry metric 528. In an example, 1308 may be performed by the error corrector 198.

In one aspect, at 1310, the apparatus may perform a comparison of a set of positions of the set of block matches, where identifying the set of error regions may include identifying the set of error regions additionally based on at least one of the computed variance, the computed symmetry metric, or the performed comparison. For example, FIG. 11 at 1114 shows that the first graphics processor component 1102 may perform a comparison of a set of positions of the set of block matches, where identifying the set of error regions at 1116 may include identifying the set of error regions additionally based on at least one of the computed variance, the computed symmetry metric, or the performed comparison. In an example, 1310 may be performed by the error corrector 198.

In one aspect, computing the symmetry metric may include: computing a horizontal neighbor block score based on the first frame and the second frame. For example, computing the symmetry metric at 1112 may include: computing a horizontal neighbor block score based on the first frame and the second frame. In an example, the aforementioned aspect may correspond to the pseudocode described above in the description of FIG. 5.

In one aspect, computing the symmetry metric may further include: computing a vertical neighbor block score based on the first frame and the second frame. For example, computing the symmetry metric at 1112 may further include: computing a vertical neighbor block score based on the first frame and the second frame. In an example, the aforementioned aspect may correspond to the pseudocode described above in the description of FIG. 5.

In one aspect, computing the symmetry metric may further include: computing a ratio of (1) a difference between the vertical neighbor block score and the horizontal neighbor block score and (2) a maximum of the vertical neighbor block score and the horizontal neighbor block score. For example, computing the symmetry metric at 1112 may further include: computing a ratio of (1) a difference between the vertical neighbor block score and the horizontal neighbor block score and (2) a maximum of the vertical neighbor block score and the horizontal neighbor block score. In an example, the aforementioned aspect may correspond to the pseudocode described above in the description of FIG. 5.

In one aspect, the set of block matches may include a first top block match and a second top block match, performing the comparison of the set of positions of the set of block matches may include comparing a first position of the first top block match to a second position of the second top block match, and identifying the set of error regions based on the comparison of the set of positions of the set of block matches may include identifying the set of error regions based on the first position and the second position not being co-located. For example, the set of block matches at 1116 may include a first top block match and a second top block match. For example, performing the comparison of the set of positions of the set of block matches at 1114 may include comparing a first position of the first top block match to a second position of the second top block match, and identifying the set of error regions based on the comparison of the set of positions of the set of block matches at 1116 may include identifying the set of error regions based on the first position and the second position not being co-located.

In one aspect, the variance may be associated with a featureless region in the first frame and the second frame, the symmetry metric may be associated with an aperture corresponding to the first frame and the second frame, and the comparison may be associated with a repeated pattern region in the first frame and the second frame. A repeated pattern may refer to graphical content that has repetitive features which are either identical or similar in structure in a frame. For example, the featureless region may be or include the stairs 406. In another example, the featureless region may correspond to the flat feature 608. A featureless region may refer to a region of a frame that does not include distinguishable features. For instance, the featureless region may be a region that includes one type of feature that cannot be differentiated within the region. In an example, the aperture may be associated with the five 8×8 block from the L1 input depicted in FIG. 4. In an example, the aperture may be associated with the stairs 406. In an example, the aperture may be associated with the aperture issue feature 708. In an example, the repeated pattern region may be or include the stairs 406. In an example, the repeated pattern region may be or include the repeating pattern feature 704.

In one aspect, the set of error regions may correspond to misidentified motion between a first region of the first frame and a second region of a second frame. For example, the misidentified motion may correspond to the misidentified motion region(s) 414. In an example, the second frame may be the second frame 404.

In one aspect, the set of block matches may include a set of N top block matches, where N is a positive integer greater than one. For example, the set of block matches at 1116 may include a set of N top block matches, where N is a positive integer greater than one.

In one aspect, performing the set of iterative downscale passes may include computing an average motion vector associated with at least one of the first frame or a second frame, and computing the average motion vector may include computing the average motion vector based on a set of motion vectors that is not associated with the identified set of error regions. For example, performing the set of iterative downscale passes at 1118 may include computing an average motion vector associated with at least one of the first frame or a second frame, and computing the average motion vector may include computing the average motion vector based on a set of motion vectors that is not associated with the identified set of error regions. An average motion vector may refer to an average of a set of motion vectors. In an example, the second frame may be the second frame 404.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for identifying, in-line, a set of error regions associated with a first frame. The apparatus may further include means for performing, in-line and based on the identified set of error regions and at least one of partial ME results of a first ME pass or partial DFS results of a first DFS pass, a set of iterative downscale passes on at least one of the partial ME results or the partial DFS results. The apparatus may further include means for generating, in-line, a global motion buffer based on the performed set of iterative downscale passes. The apparatus may further include means for performing, based on at least one of the global motion buffer or the identified set of error regions, at least one of a second ME pass or a second DFS pass. The apparatus may further include means for outputting an indication of at least one of the performed second ME pass or the performed second DFS pass. The apparatus may further include means for performing at least one of the first ME pass or the first DFS pass. The apparatus may further include means for generating, based on the performance of at least one of the first ME pass or the first DFS pass, at least one of the partial ME results of the first ME pass or the partial DFS results of the first DFS pass. The apparatus may further include means for computing, based on the first frame and a second frame and within a search window, a variance of a set of block matches of at least one of the first ME pass or the first DFS pass for the first frame and the second frame. The apparatus may further include means for computing, based on the first frame and the second frame, a symmetry metric associated with the set of block matches. The apparatus may further include means for performing a comparison of a set of positions of the set of block matches, where identifying the set of error regions includes identifying the set of error regions additionally based on at least one of the computed variance, the computed symmetry metric, or the performed comparison.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, including: identifying, in-line, a set of error regions associated with a first frame; performing, in-line and based on the identified set of error regions and at least one of partial motion estimation (ME) results of a first ME pass or partial depth from stereo (DFS) results of a first DFS pass, a set of iterative downscale passes on at least one of the partial ME results or the partial DFS results; generating, in-line, a global motion buffer based on the performed set of iterative downscale passes; and performing, based on at least one of the global motion buffer or the identified set of error regions, at least one of a second ME pass or a second DFS pass.

Aspect 2 may be combined with aspect 1, further including: outputting an indication of at least one of the performed second ME pass or the performed second DFS pass.

Aspect 3 may be combined with 2, wherein outputting the indication of at least one of the performed second ME pass or the performed second DFS pass includes: transmitting the indication of at least one of the performed second ME pass or the performed second DFS pass; or storing, in at least one of a memory, a buffer, or a cache, the indication of at least one of the performed second ME pass or the performed second DFS pass.

Aspect 4 may be combined with any of aspects 1-3, further including: performing at least one of the first ME pass or the first DFS pass; and generating, based on the performance of at least one of the first ME pass or the first DFS pass, at least one of the partial ME results of the first ME pass or the partial DFS results of the first DFS pass.

Aspect 5 may be combined with any of aspects 1-4, wherein performing at least one of the second ME pass or the second DFS pass includes performing at least one of the second ME pass or the second DFS pass further based on at least one of the partial ME results of the first ME pass or the partial DFS results of the first DFS pass.

Aspect 6 may be combined with aspect 5, wherein performing at least one of the second ME pass or the second DFS pass includes: interpolating between (1) at least one of the partial ME results or the partial DFS results and (2) the global motion buffer to generate an interpolated result; sampling the identified set of error regions; and mixing the sampled identified set of error regions with the interpolated result.

Aspect 7 may be combined with aspect 5, wherein performing at least one of the second ME pass or the second DFS pass includes: selecting (1) at least one of the partial ME results or the partial DFS results or (2) the global motion buffer; sampling the identified set of error regions; and mixing the sampled identified set of error regions with (1) at least one of the selected partial ME results or the selected partial DFS results or (2) the selected global motion buffer.

Aspect 8 may be combined with any of aspects 1-7, wherein the identification of the set of error regions, the performance of the set of iterative downscale passes, and the generation of the global motion buffer are executed in-line as part of at least one of a hierarchical ME process or a hierarchical DFS process.

Aspect 9 may be combined with any of aspects 1-8, wherein the first ME pass or the first DFS pass includes an initial ME pass or an initial DFS pass, respectively, and wherein the second ME pass or the second DFS pass includes a refinement ME pass or a refinement DFS pass, respectively.

Aspect 10 may be combined with any of aspects 1-9, wherein at least one of the partial ME results or the partial DFS results include a first resolution, and wherein the global motion buffer includes a second resolution that is less than the first resolution.

Aspect 11 may be combined with any of aspects 1-10, wherein performing the set of iterative downscale passes on at least one of the partial ME results or the partial DFS results includes: discarding a first set of motion vectors associated with at least one of the first frame or the second frame, wherein the first set of motion vectors corresponds to the identified set of error regions; and replacing the first set of motion vectors with a second set of motion vectors, wherein generating the global motion buffer includes generating the global motion buffer with the second set of motion vectors and without the first set of motion vectors.

Aspect 12 may be combined with any of aspects 1-11, further including: computing, based on the first frame and a second frame and within a search window, a variance of a set of block matches of at least one of the first ME pass or the first DFS pass for the first frame and the second frame; computing, based on the first frame and the second frame, a symmetry metric associated with the set of block matches; and performing a comparison of a set of positions of the set of block matches, wherein identifying the set of error regions includes identifying the set of error regions additionally based on at least one of the computed variance, the computed symmetry metric, or the performed comparison.

Aspect 13 may be combined with aspect 12, wherein computing the symmetry metric includes: computing a horizontal neighbor block score based on the first frame and the second frame; computing a vertical neighbor block score based on the first frame and the second frame; and computing a ratio of (1) a difference between the vertical neighbor block score and the horizontal neighbor block score and (2) a maximum of the vertical neighbor block score and the horizontal neighbor block score.

Aspect 14 may be combined with any of aspects 12-13, wherein the set of block matches includes a first top block match and a second top block match, wherein performing the comparison of the set of positions of the set of block matches includes comparing a first position of the first top block match to a second position of the second top block match, and wherein identifying the set of error regions based on the comparison of the set of positions of the set of block matches includes identifying the set of error regions based on the first position and the second position not being co-located.

Aspect 15 may be combined with any of aspects 12-14, wherein the variance is associated with a featureless region in the first frame and the second frame, wherein the symmetry metric is associated with an aperture corresponding to the first frame and the second frame, and wherein the comparison is associated with a repeated pattern region in the first frame and the second frame.

Aspect 16 may be combined with any of aspects 12-15, wherein the set of block matches includes a set of N top block matches, where N is a positive integer greater than one.

Aspect 17 may be combined with any of aspects 1-16, wherein the set of error regions corresponds to misidentified motion between a first region of the first frame and a second region of the second frame.

Aspect 18 may be combined with any of aspects 1-17, wherein performing the set of iterative downscale passes includes computing an average motion vector associated with at least one of the first frame or a second frame, and wherein computing the average motion vector includes computing the average motion vector based on a set of motion vectors that is not associated with the identified set of error regions.

Aspect 19 is an apparatus for graphics processing including a memory and a processor coupled to the memory and, based on information stored in the memory, the processor is configured to implement a method as in any of aspects 1-18.

Aspect 20 may be combined with aspect 19 and includes that the apparatus is a wireless communication device comprising at least one of an antenna or a transceiver coupled to the processor.

Aspect 21 is an apparatus for graphics processing including means for implementing a method as in any of aspects 1-18.

Aspect 22 is a computer-readable medium (e.g., a non-transitory computer-readable medium) storing computer executable code, the computer executable code, when executed by a processor, causes the processor to implement a method as in any of aspects 1-18.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
identify, in-line, a set of error regions associated with a first frame;
perform, in-line and based on the identified set of error regions and at least one of partial motion estimation (ME) results of a first ME pass or partial depth from stereo (DFS) results of a first DFS pass, a set of iterative downscale passes on at least one of the partial ME results or the partial DFS results;
generate, in-line, a global motion buffer based on the performed set of iterative downscale passes; and
perform, based on at least one of the global motion buffer or the identified set of error regions, at least one of a second ME pass or a second DFS pass.

2. The apparatus of claim 1, wherein the processor is further configured to:
output an indication of at least one of the performed second ME pass or the performed second DFS pass.

3. The apparatus of claim 2, wherein to output the indication of at least one of the performed second ME pass or the performed second DFS pass, the processor is configured to:
transmit the indication of at least one of the performed second ME pass or the performed second DFS pass; or
store, in at least one of the memory, a buffer, or a cache, the indication of at least one of the performed second ME pass or the performed second DFS pass.

4. The apparatus of claim 1, wherein the processor is further configured to:
perform at least one of the first ME pass or the first DFS pass; and
generate, based on the performance of at least one of the first ME pass or the first DFS pass, at least one of the partial ME results of the first ME pass or the partial DFS results of the first DFS pass.

5. The apparatus of claim 1, wherein to perform at least one of the second ME pass or the second DFS pass, the processor is configured to perform at least one of the second ME pass or the second DFS pass further based on at least one of the partial ME results of the first ME pass or the partial DFS results of the first DFS pass.

6. The apparatus of claim 5, wherein to perform at least one of the second ME pass or the second DFS pass, the processor is configured to:
interpolate between (1) at least one of the partial ME results or the partial DFS results and (2) the global motion buffer to generate an interpolated result;
sample the identified set of error regions; and
mix the sampled identified set of error regions with the interpolated result.

7. The apparatus of claim 5, wherein to perform at least one of the second ME pass or the second DFS pass, the processor is configured to:
select (1) at least one of the partial ME results or the partial DFS results or (2) the global motion buffer;
sample the identified set of error regions; and
mix the sampled identified set of error regions with (1) at least one of the selected partial ME results or the selected partial DFS results or (2) the selected global motion buffer.

8. The apparatus of claim 1, wherein to identify the set of error regions, perform the set of iterative downscale passes, and generate the global motion buffer, the processor is configured to identify the set of error regions, perform the set of iterative downscale passes, and generate the global motion buffer in-line as part of at least one of a hierarchical ME process or a hierarchical DFS process.

9. The apparatus of claim 1, wherein the first ME pass or the first DFS pass comprises an initial ME pass or an initial DFS pass, respectively, and wherein the second ME pass or the second DFS pass comprises a refinement ME pass or a refinement DES pass, respectively.

10. The apparatus of claim 1, wherein at least one of the partial ME results or the partial DFS results comprise a first resolution, and wherein the global motion buffer comprises a second resolution that is less than the first resolution.

11. The apparatus of claim 1, wherein to perform the set of iterative downscale passes on at least one of the partial ME results or the partial DFS results, the processor is configured to:
discard a first set of motion vectors associated with at least one of the first frame or a second frame, wherein the first set of motion vectors corresponds to the identified set of error regions; and
replace the first set of motion vectors with a second set of motion vectors, wherein to generate the global motion buffer, the processor is configured to generate the global motion buffer with the second set of motion vectors and without the first set of motion vectors.

12. The apparatus of claim 1, wherein the processor is further configured to:
compute, based on the first frame and a second frame and within a search window, a variance of a set of block matches of at least one of the first ME pass or the first DFS pass for the first frame and the second frame;
compute, based on the first frame and the second frame, a symmetry metric associated with the set of block matches; and
perform a comparison of a set of positions of the set of block matches, wherein to identify the set of error regions, the processor is configured to identify the set of error regions additionally based on at least one of the computed variance, the computed symmetry metric, or the performed comparison.

13. The apparatus of claim 12, wherein to compute the symmetry metric, the processor is configured to:
compute a horizontal neighbor block score based on the first frame and the second frame;
compute a vertical neighbor block score based on the first frame and the second frame; and
compute a ratio of (1) a difference between the vertical neighbor block score and the horizontal neighbor block score and (2) a maximum of the vertical neighbor block score and the horizontal neighbor block score.

14. The apparatus of claim 12, wherein the set of block matches comprises a first top block match and a second top block match, wherein to perform the comparison of the set of positions of the set of block matches, the processor is configured to compare a first position of the first top block match to a second position of the second top block match, and wherein to identify the set of error regions based on the comparison of the set of positions of the set of block matches, the processor is configured to identify the set of error regions based on the first position and the second position not being co-located.

15. The apparatus of claim 12, wherein the variance is associated with a featureless region in the first frame and the second frame, wherein the symmetry metric is associated with an aperture corresponding to the first frame and the second frame, and wherein the comparison is associated with a repeated pattern region in the first frame and the second frame.

16. The apparatus of claim 12, wherein the set of block matches comprises a set of N top block matches, where N is a positive integer greater than one.

17. The apparatus of claim 1, wherein the set of error regions corresponds to misidentified motion between a first region of the first frame and a second region of a second frame.

18. The apparatus of claim 1, wherein the apparatus is a wireless communication device comprising at least one of an antenna or a transceiver coupled to the processor.

19. A method of graphics processing, comprising:
identifying, in-line, a set of error regions associated with a first frame;
performing, in-line and based on the identified set of error regions and at least one of partial motion estimation (ME) results of a first ME pass or partial depth from stereo (DFS) results of a first DFS pass, a set of iterative downscale passes on at least one of the partial ME results or the partial DFS results;
generating, in-line, a global motion buffer based on the performed set of iterative downscale passes; and
performing, based on at least one of the global motion buffer or the identified set of error regions, at least one of a second ME pass or a second DFS pass.

20. A computer-readable medium storing computer executable code, the computer executable code, when executed by a processor, causes the processor to:
identify, in-line, a set of error regions associated with a first frame;
perform, in-line and based on the identified set of error regions and at least one of partial motion estimation (ME) results of a first ME pass or partial depth from stereo (DFS) results of a first DFS pass, a set of iterative downscale passes on at least one of the partial ME results or the partial DFS results;
generate, in-line, a global motion buffer based on the performed set of iterative downscale passes; and
perform, based on at least one of the global motion buffer or the identified set of error regions, at least one of a second ME pass or a second DFS pass.
